(19) United States
(12) Patent Application Publication
(10) Pub. No.: US 2021/0066899 A1
(43) Pub. Date: Mar. 4, 2021

(54) Cap and Method for Providing an Insulation Cap on a Stator Head

(71) Applicant: GE Renewable Energy Canada, Québec (CA)

(72) Inventor: Franck Régis, René Palaticky, Québec (CA)

(21) Appl. No.: 16/961,274

(22) PCT Filed: Jan. 11, 2019
(86) PCT No.: PCT/EP2019/050633

§ 371 Date: Jul. 10, 2020

(30) Foreign Application Priority Data
Jan. 11, 2018 (GB) 1800459.8

(51) Int. Cl. H02G 1/14; H02K 3/38; H02G 15/113

(52) U.S. Cl. CPC H02G 1/14; H02G 15/113; H02K 3/38

(57) ABSTRACT

The invention relates to a cap (10) for providing an insulation cap on the stator head (25) of an electric machine, the cap (10) having cap-parts (12, 13) comprising clipping arrangements (17) for clipping to one another when the cap (10) is closed. Preferably, the clipping arrangements (17) comprise inter-engaging hooks (18, 19) which can snap-fit together. The invention also relates to a method for providing an insulation cap on the stator head (25) of an electric machine. This invention is particularly suitable for providing insulation caps on the stator heads (25) at the top of vertical electrical machines.

### TECHNICAL FIELD

The invention relates to the field of electrodynamic machines (electric machines). More particularly, the invention relates to a cap for providing an insulation cap on a stator head of an electric machine, and a method for providing an insulation cap on a stator head of an electrodynamic machine.

### PRIOR ART

The stators of electric machines, e.g. electric generators, comprise windings. Each winding comprises two somewhat-parallel bars, and a lug brazed onto the bars to electrically connect the bars, in a general U-shape. The lug, along with the portions of the two bars adjacent to the lug, form the stator winding head, or simply stator head.

The stator heads need to be dielectrically insulated. In order to insulate the stator heads, insulation caps are provided. This usually involves the attachment of a cap onto the stator head, and the provision of a filler material between the two which cures and secures the cap to the stator head and thereby forming the insulation cap. Typically, a non-conducting cap rated to the required dielectric resistance is first provisionally attached to the stator head, and subsequently a resin introduced to fill the space between the two and left to cure to secure the cap to the stator head.

Providing insulation caps on the bottom of a vertical stator is rather straightforward as the cap opening is facing upwards, however providing insulation caps on the top is complex as the cap opening to be filled is facing downwards (stator head is an inverted U). In particular, with the cap being upside down, the resin tends to flow down and away from the insulation cap to be fabricated. This makes the installation problematic, the leaking resin being hard to control, potentially damaging the winding and affecting the intended quality of the finished insulation cap. In certain cases, a high-viscosity resin, such as a paste, has been provided for caps at the top of the stator, however not only is it harder to completely fill the cap with paste by hand, having two different resins also increases costs and logistics.

EP2961045 A1 (Alstom) attempts to solve this problem by first attaching a container to the bars at the base of the stator head, and then filling with a moulding compound. A cap is then provided such that it encases the stator head, and its bottom provided in the moulding compound within the container. Once the moulding compound has cured and the bottom of the cap sealed, dielectric compound is introduced through a hole in the cap. This dielectric compound cures to provide, together with the cap, an insulated cap.

Unfortunately, this approach is complicated, comprises several components and compounds, and is particularly time-consuming as the moulding compound has to cure prior to the dielectric compound being filled into the cap. Furthermore, to complete the procedure, the container along with the cured moulding compound need to be removed.

U.S. Pat. No. 4,621,212 A (GE) is prior art which corresponds to known aspects of the invention. It discloses a cap having two half-shells forming a cavity, the two half-shells closing around the stator head such that it is encased in the cavity, the half-shells held in place by straps. High-viscosity resin is injected into the cap through a sprue tube and nipple connected to the cap. This compound cures to provide, together with the cap, an insulated cap on the stator head.

Unfortunately, this approach is also complicated and time-consuming. Firstly, attaching straps to the cap in a restricted space can be tedious. Next, the high-viscosity resin is not only hard to manipulate and mix homogeneously on site, it further requires equipment capable of injecting it into the cap. Furthermore, once the resin has cured, the straps have to be removed and the sprue tube cut. Finally, the junction of the half-shells on the finished insulation cap is not smooth, reducing dielectric performance.

Yet other solutions have been proposed, but they have not been satisfactory for reasons of high cost, assembly being too complicated, part-count being too high, small size of components posing a risk of being dropped into the electric machine, etc.

As such, there is clearly a need to for a quicker and easier way of providing an insulation cap on a stator head of an electric machine.

### BRIEF DESCRIPTION OF THE INVENTION

The present invention concerns a cap, preferably for providing an insulation cap on the stator head of an electric machine. The cap preferably comprises at least two cap-parts which may be arranged to be attached to the stator head by being closed the around the stator head. The cap preferably defines, when closed, a cavity for encasing the stator head. The cap may also define openings for fitting around the bars of stator head, and/or a hole for providing a filler material into the cavity. The cap may be adapted to remain on the stator head and together with the filler material may become an insulation cap for the stator head. The cap-parts may comprise clipping arrangements for clipping to one another when the cap is closed.

The present invention also concerns a method for providing an insulation cap on the stator head of an electric machine, preferably with a cap as defined above. The method preferably comprises one or more of the following: attaching a cap to the stator head preferably by closing cap-parts around the stator head to encase the stator head in a cavity with the two bars protruding out, preferably from the cap-parts; clipping clipping arrangements of the cap-parts to one another; introducing a filler material preferably via an opening into the cavity; and curing the filler material such that the cap preferably becomes, together with the filler material, an insulation cap on the stator head of the electric machine.

Further preferable features of the invention are defined in the appendant claims.

### BRIEF DESCRIPTION OF THE FIGURES

The invention will be better understood when reading the following detailed description and non-limiting examples, as well as studying the figures, wherein:

FIG. 1 shows a perspective view of the cap with the stator head encased in the cavity, according to a preferred embodiment of the invention,

FIG. 2 show a perspective view of the cap with one shell removed and one shell remaining, showing the stator head positioned within,

FIG. 3 shows a cross-section view at the junction of the two shells of the cap, revealing the clipping arrangement, and

FIG. 4 show a perspective view of the top of the cap, when closed, showing the holes for filling the resin.

In all of these figures, identical references can designate identical or similar elements. In addition, the various portions shown in the figures are not necessarily shown according to a uniform scale, in order to make the figures more legible.

### DETAILED DESCRIPTION OF PARTICULAR EMBODIMENTS

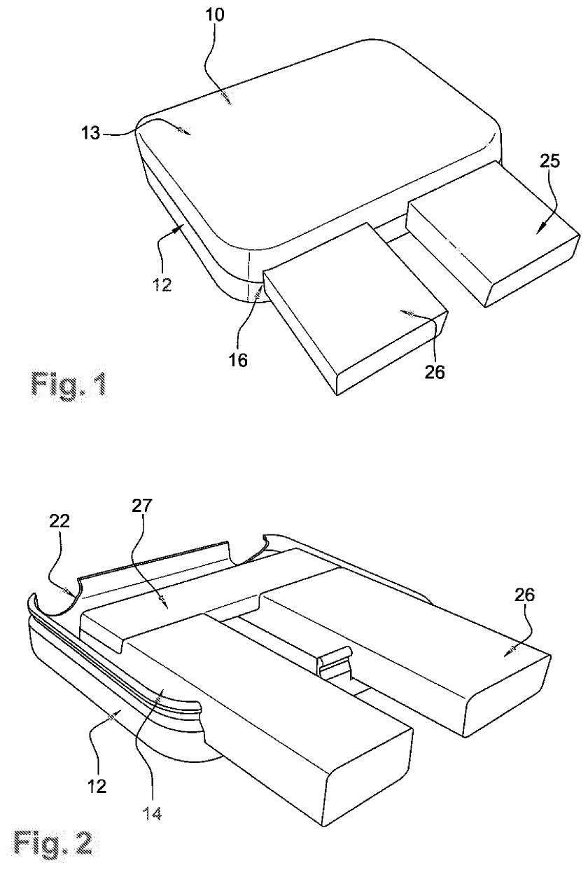

FIG. 1 shows a cap 10 comprising two parts 12, 13 which are closed with the stator head 25 encased in the cavity 14. The cap 10 is generally in the form of a rectangular case with rounded edges and corners, and made of made of a non-conducting plastics material rated to the required dielectric resistance. The two bars 26 of the stator winding which lead up to the stator head 25 are visible, protruding through openings 16 in the cap 10. While the cap 10 may be made up of more than two cap-parts, the cap in this embodiment is made up of only two cap-parts 12, 13.

FIG. 2 shows the same cap 10 with one of the cap-parts removed to reveal the cavity 14 and the stator head 25 (with bars 26 and lug 27). The two cap-parts 12, 13 each have a recess, essentially forming shells 12, 13. When the cap 10 is closed, the recesses of the shells 12, 13 are brought together to define a cavity 14 to receive the stator head 25. The two cap-parts 12, 13 in these figures are not identical in structure and size, but are similar. The first shell 12 is arranged to receive the stator head 25 slightly deeper in its recess compared to the second shell 13. It also defines at its periphery 22 more of the openings 16 for fitting around the bars 26 of/leading to the stator head 25.

The openings 16 for the bars 26 of the windings, are dimensioned so as to be a close fit around the bars 26. By this, it is intended that the cap 10 fits closely enough such that leakage of filler material (not shown), epoxy resin in this embodiment, between the bars 26 and cap 10 at the opening 16 is negligible or non-existent. Possibly, a sealing material may be integrated into the sides of the opening 16 (at the periphery of the shell) to facilitate sealing between the cap 10 and the bars 26 of the stator head 25. Alternatively, where the fit is not close, a sealing tape could be wound around the bars 26 to prevent leakage from the openings 16.

Various methods may be used to produce the cap 10, which can be manufactured to varying dimensions to accommodate different stator head sizes. It also lends itself well to 3D-manufacturing. The cap 10 can even be made of three or four parts, or more, although it is generally intended to keep part-count low. Of course, the shells 12, 13 making up the cap 10 may both be of the same general shape and size. In one specific embodiment which can be envisaged, the cap is made of identical halves, which are capable of being clipped together to form the whole cap. This could speed up production and further reduce cost.

Also visible in FIG. 2, are portions of the holes 20 for pouring filler material, which will be discussed later on, and portions of the clipping arrangements 17 for the cap 10. The clipping arrangements 17 enable the shells 12, 13 to connect to each other. The clipping arrangements 17 in this preferred embodiment take the form of inter-engaging hooks, which snap-fit together when the shells are brought together and closed.

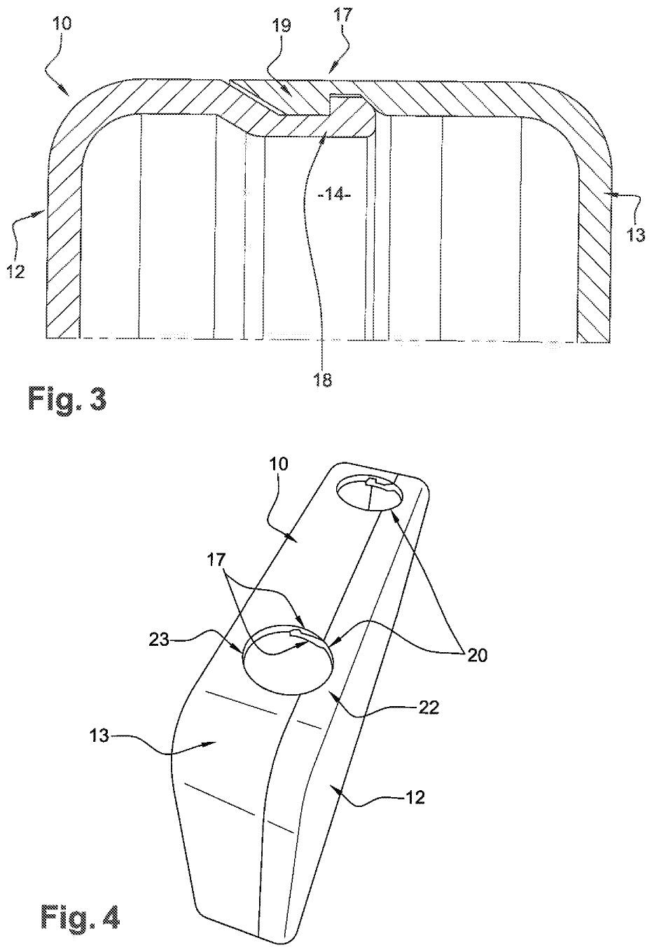

FIG. 3 shows these inter-engaging hooks 18, 19 in further detail. It shows a cross-section at the junction of the shells 12, 13 when the cap 10 is closed. When aligned and pressed together, the inter-engaging hooks 18, 19 of each shell 12, 13 ride over the other and snap-fit together. To enable this, they have sufficient structural flexibility. The inter-engaging hooks 18, 19 may be provided at discrete points on the shells 12, 13, or as shown in the figures, along most of the periphery 22, 23 of the shells 12, 13 (i.e. the entire periphery except space for any openings or holes). They serve to hold the cap 10 closed, effectively serving as a lock to prevent it opening up again. Once it is closed with the stator head 25 inside, it is very difficult to remove the cap 10.

Clipping arrangements 17 such as these are advantageous as they as they are easy to operate as compared to straps and clamps. This means that a person providing the cap 10 on the stator head 25 will be able to do so just using his hands on the cap-parts. Especially in the two-part cap embodiment, the user will be able to attach it to the stator head 25 easily and quickly by hand, and without requiring any tools. Furthermore, the clipping arrangements 17 can be provided integrally on the cap 10 during manufacture, and are ideally made of the same material as the rest of the cap 10.

As the cap 10 is designed to be filled by pouring in resin and allowing gravity to fill the cap and not, for example, filled by injecting a high-viscosity resin which subjects the cavity to pressure, there is no risk of the inter-engaging hooks 18, 19 releasing and shells 12, 13 separating when filling the cavity 14. Equally, there would be no need for straps or clamps either. Studying the profile of the inter-engaging hooks 18, 19 we note that a convoluted leakage path is formed capable of preventing the escape of resin.

Another advantage is that the external surface of the shells 12, 13 at the junction is flush. As the junction is smooth, the dielectric insulation performance of the finished insulation cap will not be reduced. While inter-engaging hooks 18, 19 which can snap-fit are preferred, other forms of clipping arrangements 17 will also be applicable. For example, hooks on one shell may engage notches on the other shell. Clipping arrangements 17 which are not hook-form but which are able to snap-fit may also be suitable. The various clipping arrangements 17 suitable for this cap 10 will be evident to the skill person in light of the above disclosure and so will not be discussed in further detail.

FIG. 4 is a perspective view from above the cap 10, showing two holes 20 for introducing filler material, i.e. epoxy resin, formed at the junction between the shells 12, 13. These holes 20 are formed once the shells 12, 13 are brought together and the cap 10 is closed. Optionally, these holes 20 may be provided entirely on one of the shells 12, 13, and sometimes only one hole 20 may be provided on the cap 10.

The location of the hole 20 on the cap may differ depending on the orientation it is to occupy on the electric machine, optimised for filling by pouring. In other words, the hole 20 is provided such that it will essentially occupy the highest point on the cap 10 once it is installed on the stator head 25, which will facilitate the resin being poured into the cavity 14 and filling only by gravity. Accordingly, in the typical orientation when the cap 10 is attached to the stator head 25 the top of the stator, the holes 20 for the filler material will be located on the opposite end of the cap 10 to the openings 16 to accommodate the bars 26.

It can be envisaged that where this cap 10 is employed for the stator heads 25 located at the bottom, the hole 20 for the filler material will be located in the vicinity of the openings 16 for the bars 26, and although usually separate, possibly even be the same as the opening 16 for one of the bars, the opening 16 dimensioned not to fit so closely around the bar 26 so that space remains to introduce resin.

Positioning tabs may optionally be provided within the cap 10, to allow correct positioning (height, spacing, etc.) with respect to the stator head 25. Preferably, the tabs are arranged to cage the stator head 25 such that the cap 10 will not move once the cap 10 is closed around the stator head 25. In one particular embodiment, the tabs allow the cap 10 to be attached to the stator head 25 in one position only, reducing errors in attaching the cap 10 on the stator head 25.

Once the resin is poured in and has cured, it will be appreciated that the solidified resin adjacent the hooks 18, 19 severely restricts their flexibility, making removal very difficult and thereby assuring that the cap 10 stays together with the resin. The cap 10 is an integral part of the insulation cap, which is formed together by the cap 10 and the solidified resin. It is not meant to be subsequently removed. In certain cases, the material of the cap 10 is arranged to chemically bond to the introduced resin. Typically, the cap 10 provides the primary insulation for the stator head 25.

A method for providing an insulation cap on a stator head 25 on a stator of an electric machine with the cap 10 of the invention will now be briefly described. The cap 10 is attached to the stator head 25 by bringing the (open cap) shells 12, 13 together and closing the cap 10 around the stator head 25 so that the stator head 25 is encased in the cavity 14 of the cap 10. To close the cap 10, the shells 12, 13 are generally aligned and pressed together by hand, so that the inter-engaging hooks 18 on one shell 12 engage the corresponding inter-engaging hooks 19 on the second shell 13 and snap-fit when the cap 10 is closed. The hole 20 for filling resin is provided such that it is as the highest point of the cap 10 in the orientation it assumes on the stator head 25, which will be above the openings 16 for the bars 26.

Subsequently, resin is poured into the hole 20 by hand, and allowed to flow into and fill the cavity 14 only aided by gravity. Ideally, a low-viscosity resin is used so that the entire cavity 14 can be filled without trapping bubbles or forming voids. The resin will find its way to fill all the spaces in the cavity 14 between the stator head 25 and the cap 10. The convoluted leakage path provided by the clipping arrangements 17 prevents the escape of resin through the junction. Of course, this may alternatively or additionally be achieved by arranging the inter-engaging hooks 18, 19 to press and seal against each. This resin is left to cure and solidify. The cap 10 is left together with the resin to form the insulation cap on the stator head 25. The cap 10 forms an integral part of the insulation cap, and is not intended to be removed once the resin has cured.

The invention allows an insulation cap to be provided on the stator head 25 easily, quickly and reliably. Assembly time is significantly reduced as the cap 10 is made of very few parts 12, 13 which just need to be clipped together. No clamps, straps, fasteners or tools are required for the installation of the cap 10. On top of that, filler material just needs to be poured into the hole 20 on the cap 10, and allowed fill the cavity 14 by gravity. The filler material does not specifically need to be of a high-viscosity, nor does it need to be pumped into the cap 10. This allow the same resin to be employed for both the top and bottom of the stator.

The clipping arrangement 17 is also able to prevent resin from escaping. Once the resin in the cap 10 has cured, the cap 10 is secured to the stator head 25, and the insulation cap is complete. No further procedure needs to be done, such as the removal of moulding components, or other finishing steps. Finally, the cap 10 can readily be produced with 3D-manufacturing, allowing a cap to be provided on-site to specific dimensional requirements, and is also suitable for replacing or repaired existing insulating caps.

The invention is not to be limited by the preferred embodiment discussed above. While the cap has been discussed in relation to situations where the cap is on the top of the stator head and opening for bars near the bottom, it will be understood that it can equally be applied to stator heads in other orientations, with an appropriately positioned hole. Further, the invention is not limited to vertical stators and can be utilised in horizontal stators.

Other shapes for the cap can be envisaged. For example, the cap of the preferred embodiment may be modified with the first shell made deeper, and the second shell made almost flat. In another embodiment, a cap may have a first cap-part defining a cavity conforming closely to the shape of the stator head and having a large opening allowing it to be slid over the stator head with the bars protruding out, and the spacing between the bars closed off by a second cap-part to enclose the stator head. In yet another embodiment, the cap-parts may be interlinked, e.g. by a living hinge.

While the insulation is provided primarily by the cap and the resin provides little or none, the insulation cap may be arranged such that the resin provides most or all of the dielectric insulation while the cap provides little or none, serving primarily as a mould for the resin.

1-16. (canceled)

17. A cap for providing an insulation cap on the stator head of an electric machine, the cap comprising:
at least two cap-parts arranged to attach to the stator head by being closed around the stator head,
the cap defining, when closed, a cavity for encasing the stator head, openings for fitting around at least one bar of the stator head, and a hole for providing a filler material into the cavity.
the cap adapted to remain on the stator head and together with the filler material become an insulation cap for the stator head; and
the cap-parts comprising clipping arrangements for clipping to one another when the cap is closed.

18. The cap according to claim 17, wherein the cap consists of two cap-parts.

19. The cap according to claim 18, wherein the two cap-parts are formed as shells.

20. The cap according to claim 17, wherein the clipping arrangements comprises inter-engaging hooks arranged to snap-fit together when the cap is closed.

21. The cap according to claim 20, wherein the inter-engaging hooks are provided along a periphery of the cap-parts.

22. The cap according to claim 17, wherein the openings for fitting around the at least one bar are defined by a periphery of the cap-parts.

23. A stator of an electric machine, comprising:
a cap on a head of the stator, the cap comprising:
at least two cap-parts closed around the stator head;
the cap defining a cavity that encases the stator head, openings through which at least one bar of the stator head extends, and a hole for providing a filler material into the cavity;
the cavity filled with cured filler material, wherein the cap together with the filler material forms an insulation cap for the stator head

24. The stator according to claim 23, wherein the cap provides a primary insulation for the stator head as compared to the cured filler material.

25. The stator according to claim 23, wherein the cured filler material in the cap secures the cap to the stator head.

26. A method for providing an insulation cap on a stator head of an electric machine with a cap, the method comprising:
attaching the cap to the stator head by closing cap-parts around the stator head to encase the stator head in a cavity with at least one bar of the stator head protruding out through an opening in the cap;
wherein the cap-parts comprise clipping arrangements and the method comprises clipping the clipping arrangements to one another,
introducing a filler material via an opening into the cavity; and
curing the filler material such that the cap becomes, together with the filler material, the insulation cap on the stator head of the electric machine.

27. The method according to claim 26, further comprising:
providing the cap-parts with inter-engaging hooks; and
snap-fitting the cap-parts to one another.

28. The method according to claim 26, wherein the cap has only two of the cap-parts closed around the stator head.

29. The method according to claim 26, comprising providing the opening for the tiller material in a surface of the cap opposite the opening for the bar.

30. The method according to claim 26, wherein the cap is attached to the stator head by hand, and the filler material is poured by hand into the opening in the cavity.

31. The method according to claim 30, wherein the filler material fills the cavity primarily with the aid of gravity.

32. The method according to claim 26, wherein the cap is in accordance with claim 17.
